(19) United States
(12) Patent Application Publication
(10) Pub. No.: US 2015/0271128 A1
(43) Pub. Date: Sep. 24, 2015

(54) NOVEL EMAIL MESSAGE SYSTEM AND METHOD

(71) Applicants: Keith M. Mantey, Plano, TX (US); Wei Wei Jeang, Plano, TX (US)

(72) Inventors: Keith M. Mantey, Plano, TX (US); Wei Wei Jeang, Plano, TX (US)

(21) Appl. No.: 14/221,573

(22) Filed: Mar. 21, 2014

(51) Int. Cl. H04L 12/58; G06F 3/0482

(52) U.S. Cl. CPC H04L 51/36; G06F 3/0482

(57) ABSTRACT

An email message system comprises a user interface adapted to display, in a first area on a screen, a collection of at least one email message, the user interface adapted to enable user input to select a particular email message from the collection, and the user interface adapted to enable user input to associate at least one information element with the selected email message.

### FIELD

This disclosure primarily relates to a new email message system and method.

### BACKGROUND

Electronic mail or email is a primarily means of digital communication between people in the present time. A study shows that 85% of the world's population communicated in 2012 via email. Another study indicated that the number of email accounts worldwide was 3.9 billion in 2013, and is expected to exceed 4.9 billion in 2017. The business sector accounted for over 100 billion email messages sent and received each day in 2013. Although text messaging and social media provide new avenues of digital communication, the electronic mail is still the go-to form of communication in the business world.

### DETAILED DESCRIPTION

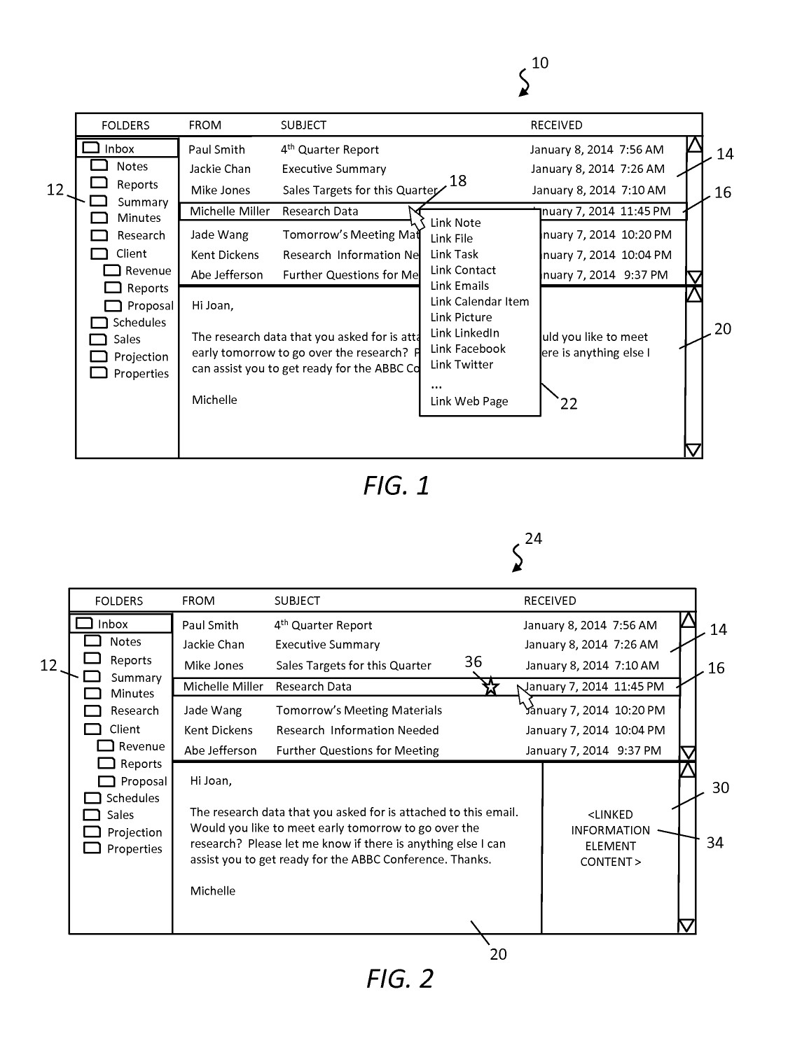

FIG. 1 is a screen shot of an exemplary embodiment of a new email message system and method according to the teachings of the disclosure;

FIG. 2 is a screen shot of an exemplary embodiment of a new email message system and method according to the teachings of the disclosure;

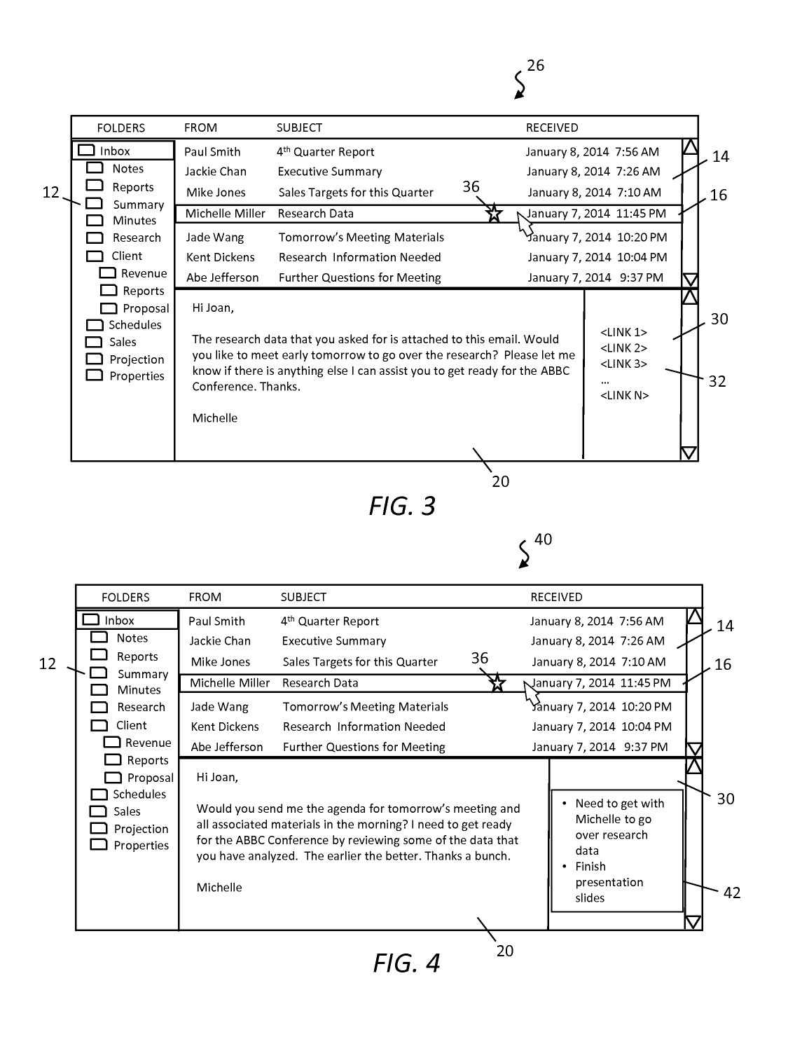

FIG. 3 is a screen shot of an exemplary embodiment of a new email message system and method according to the teachings of the disclosure;

FIG. 4 is a screen shot of an exemplary embodiment of a new email message system and method according to the teachings of the disclosure;

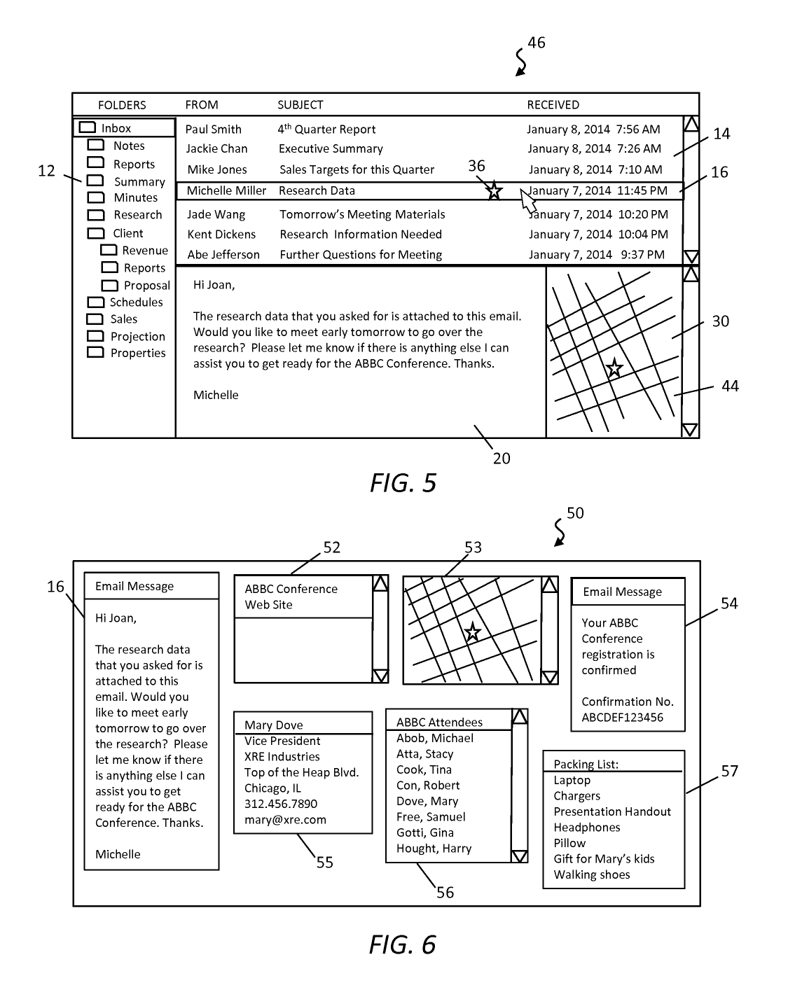

FIG. 5 is a screen shot of an exemplary embodiment of a new email message system and method according to the teachings of the disclosure;

FIG. 6 is a screen shot of an exemplary embodiment of a new email message system and method according to the teachings of the disclosure; and

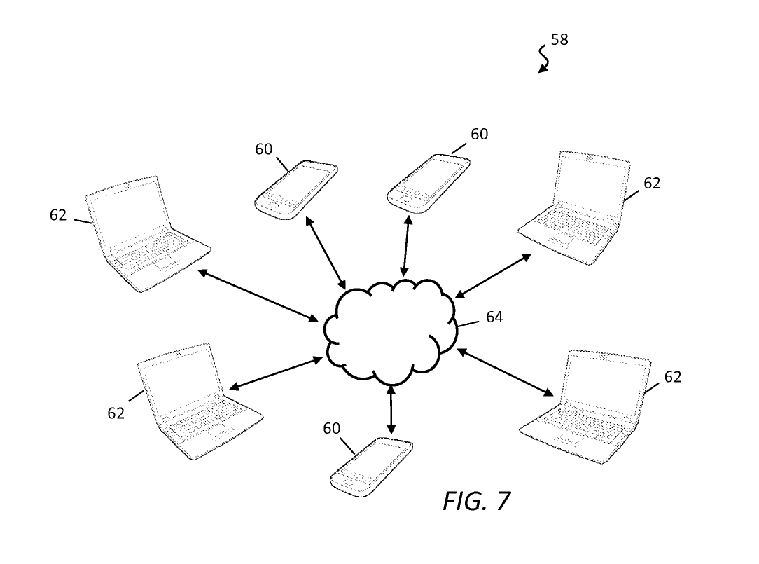

FIG. 7 is a block diagram of an exemplary operating environment of the new email message system and method according to the teachings of the disclosure.

### DETAILED DESCRIPTION

Although the email message has been and remains to be the primary form of communication in the business world, the basic email message system and method such as the MICROSOFT OUTLOOK remain somewhat stagnant and saw no significant technical advancement. Although the web-based GMAIL brought distinct ways to organize the email messages, the treatment of email messages is still not given the import and consideration consistent with how much of today's business is transacted and communicated via email. The new email system and method described herein provide ways to link or associate disparate information elements with an email message, so that users may easily access a variety of information related to that particular email message. In this way, a user does not need to recall where the disparate information items are located or stored, and can easily obtain and review all the information necessary to take action.

As an example, a user receives an email notification of an upcoming conference. The user may link that email notification with an email message confirming conference registration. The user may link the presentation slides of a talk she prepared to present at the conference to the email. The user may also link a GOOGLE map showing the conference venue to the email. The user may jot down a note containing a packing list and associate the note with the email notification message. The user may further link social media postings related to the conference to that email message.

FIG. 1 is a screen shot 10 of an exemplary embodiment of a new email message system and method according to the teachings of the disclosure. The new email message system and method comprises a user interface that is adapted to display in a first area 12 a list of folders, collection, or grouping in which email messages are organized. The grouping of email messages may be email messages in an inbox, that have been sent, that have been deleted, that are in draft form, or that have been received and relate to a particular subject matter, for example. In a second area of the screen 14, a list of messages organized in a selected folder or grouping is shown. In this example, the collection of emails in an Inbox is selected. In this example, a particular message 16 sent by Frank Miller with a subject of “Meeting Agenda” is selected by using a pointer or cursor 18. The contents of the selected message 16 is shown in a third area of the screen 20. The user may further select the message for special treatment according to the disclosure. For example, the user may right click on a specific message, and a menu or drop down list 22 appears. The menu 22 lists several options for linking or associating the selected message 16 with one or more information elements, including notes, files, tasks, contacts, email messages, calendar items, pictures, and web-based resources. An email message may be linked to several different types of information elements. If there is a linked information element, then a fourth area of the screen 30, would be used to display the content of the information element 32 or a pointer or link 34 thereto as shown in the exemplary screen shots 24 in FIG. 2 and screen shot 26 in FIG. 3. If there are multiple information elements linked to the email message, then the fourth area of the screen would display multiple icons each representing a linked information element, or display multiple links that point to multiple information elements.

As an alternative or in addition to displaying the Linked Element Content 32 or Link 34, a unique symbol, represented by a star 36, may be displayed with the selected message in the message list to indicate that a note is associated with the selected message and can be accessed.

As additional options, a user may incorporate all of the linked information elements with functions that may be performed with respect to the selected email message. For example, the user may choose to print the selected email message along with all of the information elements associated therewith. The user may also forward an email message along with all of its associated information elements to another email recipient.

As shown in FIG. 1, the menu 22 may include the option of linking the selected message 16 with one or more notes, the Link Note option. The note may be an existing note that has already been composed and stored, or a note that can be written immediately after the Link Note option has been selected. For example, after selecting Link Note, a small text box may be displayed that permits the user to immediately insert or write a note, and save it. In one exemplary implementation, the fourth area of the screen or a text box 30 is displayed in response to the selection of the Link Note option, to permit the user to enter text in the area. By providing the immediate note option, a user may immediately jot down thoughts, impressions, comments, feedback, or other information related to the selected message 16. The email may also be linked to an existing note stored on the computer, in another software application (such as Evernote) that is web-based or stored elsewhere in a cloud (e.g., Internet and World Wide Web), for example. Upon user selection of existing note option, a dialog box to enable the user to browse for an existing document can be displayed.

For example shown in the exemplary screen shot 40 in FIG. 4, in response to receiving and reading the email containing a meeting agenda, the user may jot down information in a text box 42 displayed in the fourth area 30.

The next time the same message 16 is selected, the linked note is also readily accessible. As shown in FIG. 4, the content of the note is displayed on the screen in a text box 42 in the fourth area of the screen 30. Alternatively as shown in FIG. 3, a link or pointer (e.g., file address path, URL, etc.) 32 to access the stored note may be displayed. The user may click on the Link 32 to easily access the stored note. As another alternative or in addition to displaying the Link or Linked Element Content, a unique symbol, represented by a star 36, may be displayed with the selected message in the message list to indicate that a note is associated with the selected message and can be accessed.

The menu 22 may also include a Link File option. This option permits the user to link or associate the selected message 16 with one or more existing file stored in the computer or device, or somewhere in the cloud or in the Internet. For example, in response to receiving and reading the email containing a meeting agenda, the user may link to the email a file containing research data to be presented at the meeting, and a file containing presentation slides that will be used at the meeting.

The menu 22 may also include a Link Task option. This option permits the user to link or associate the selected message 16 with an existing task or to create a task item. The existing task may be stored in the computer or device, or somewhere in the cloud or in the Internet. For example, in response to receiving and reading the email containing a meeting agenda, the user may create a task or link to an existing task to get input of a colleague in order to prepare for the upcoming meeting.

The menu 22 may further include a Link Contact option. This option permits the user to link or associate the selected message 16 with an existing contact in a digital address book or to create a new contact. The existing contact may be stored in the computer or device by the same or different email software application, or somewhere in the cloud or in the Internet by another software application. For example, in response to receiving and reading the email containing a meeting agenda, the user may create a new contact to include one of the message recipients who will be attending the meeting, or link to an existing contact.

The menu 22 may further include a Link Emails option. This option permits the user to link or associate the selected message 16 with another email message in the Inbox or another email folder in the same email application. Alternatively, the selected email message may be linked with an existing email message stored in a different email system such as Gmail or Yahoo Mail. For example, in response to receiving and reading the email containing a meeting agenda, the user may link the message to one or more other prior email messages that are related to the same subject matter, i.e., the meeting. The linked email messages may but do not need to share identical elements, such as the same recipient, same subject, or same sender. In addition to email messages, it is contemplated that the email message may be linked or associated with one or more text messages or multimedia messages received by a different software application.

The menu 22 may further include a Link Calendar Item option. This option permits the user to link or associate the selected message 16 with an existing calendar item or to create a new calendar item. The existing calendar item may be stored in the computer or device by the same or a different software application, or somewhere in the cloud or in the Internet by another software application. For example, in response to receiving and reading the email containing a meeting agenda, the user may create a new calendar appointment to meet with a colleague to go over some data in advance of the meeting, or link to an existing appointment.

The menu 22 may further include a Link Picture option. This option permits the user to link or associate the selected message 16 with a stored picture or graphic element or to create a new picture. The existing picture or graphic element may be stored in the computer or device, or somewhere in the cloud or in the Internet, and can be in any existing format or one that is developed in the future. For example, in response to receiving and reading the email containing a meeting agenda, the user may link to a map 44 of the meeting place as shown in an exemplary screen shot 46 in FIG. 5.

The menu 22 may further include options to enable the user to link an email to a web-based information item, such as a LINKEDIN profile, a FACEBOOK wall or post, a TWITTER feed, a PINTEREST pin, an INSTAGRAM photo, an RSS feed, a PODCAST, and a web page, for example. These options permit the user to link or associate the selected message 16 with an information item that is stored in the computer or device (after downloading from the Internet), or somewhere in the cloud or in the Internet. The linked web-based resource may be a simplified or stripped-down version of the actual web information element and is stored in the computing device running the new email system.

Referring to FIG. 6, an exemplary screen shot 50 illustrates how the selected email message 16 and its associated information elements may be viewed at a glance. For example, the user may choose to view the email message 16 with all of its linked information elements: a web page 52, a map/graphic element 53, another email message 54, a contact 55, a document file 56, and a note 57. These dialog boxes may be moved, arranged, and resized on the screen to suit the user's preference. In addition to displaying the associated information elements, the user may also print the selected email message 16 along with all of the information elements 52-57 associated therewith. The user may also forward the email message 16 along with all of its associated information elements 52-57 to another email recipient.

FIG. 7 is a block diagram of an exemplary operating environment 58 of the new email message system and method according to the teachings of the disclosure. The new email message system may comprise application software that is adapted for execution on a variety of computer platforms, including mobile devices 60 (e.g., smartphone, tablet computers, GOOGLE GLASSES, GOOGLE WATCH, wearable technology, etc.), laptop computers 62, and desktop computers. The software application may also be a web-based system that resides on a web server in the cloud 64. The email message system permits users to compose email messages and send them to other users. The linked information item, i.e., note, file, task, contact, email message, calendar item, picture, and web-based information item, may be stored in a computing platform or in the cloud 64, with or independent of the email software application.

It should be understood that the features disclosed herein may be embodied in a full email software application with a full suite of email functionality, or be incorporated into a plug-in that may work cooperatively with a full email software application. These features may be embodied in a software application that may be installed in any computing platform under any operating system, including mobile platform operating systems.

The features of the present invention which are believed to be novel are set forth below with particularity in the appended claims. However, modifications, variations, and changes to the exemplary embodiments described above will be apparent to those skilled in the art, and the new email message system and method described herein thus encompass such modifications, variations, and changes and are not limited to the specific embodiments described herein.

What is claimed is:

1. An email message system comprising:
a user interface adapted to display, in a first area on a screen, a collection of at least one email message;
the user interface adapted to enable user input to select a particular email message from the collection; and
the user interface adapted to enable user input to associate at least one information element with the selected email message.

2. The email message system of claim 1, wherein the information element is selected from the group consisting of a note, a file, a task, a contact, an email message, a calendar item, a picture, and a web-based information element.

3. The email message system of claim 2, wherein the web-based information element is selected from the group consisting of a LinkedIn profile, a Facebook post, a Twitter feed, a Pinterest pin, an Instagram photo, an RSS feed, a Podcast, and a web page.

4. The email message system of claim 1, wherein the user interface is further adapted to receive a user selection of a particular email message and to display, in a second area on the screen, a content of the linked information element associated with the selected email message.

5. The email message system of claim 1, wherein the user interface is further adapted to receive a user selection of a particular email message and to display, in a second area on the screen, a link to the linked information element associated with the selected email message.

6. The email message system of claim 1, wherein the user interface is further adapted to receive a user selection of a particular email message and to display, in a second area on the screen, an address to the linked information element associated with the selected email message.

7. The email message system of claim 1, wherein the user interface is adapted to associate with the selected email message at least one information element stored on a computer on which the email message system resides.

8. The email message system of claim 1, wherein the user interface is adapted to associate with the selected email message at least one information element stored in a computer wirelessly coupled to a computer running the email message system.

9. The email message system of claim 1, wherein the user interface is adapted to associate with the selected email message at least one information element stored in a computer that is part of the Internet.

10. The email message system of claim 1, wherein the user interface is adapt to display the selected email message and the at least one linked information element.

11. The email message system of claim 1, wherein the user interface is adapt to print the selected email message and the at least one linked information element.

12. The email message system of claim 1, wherein the user interface is adapt to forward to another user the selected email message and the at least one linked information element.

13. An email message method comprising:
displaying, in a first area on a screen, a collection of at least one email message;
receiving a user selection of a particular email message from the collection;
receiving user input to associate at least one information element with the selected email message; and
displaying, in a second area on the screen, the at least one information element.

14. The email message method of claim 13, wherein receiving user input to associate at least one information element with the selected email message comprises receiving an information element selected from the group consisting of a note, a file, a task, a contact, an email message, a calendar item, a picture, and a web-based information element.

15. The email message method of claim 14, wherein receiving user input to associate at least one information element with the selected email message comprises receiving a web-based information element selected from the group consisting of a LinkedIn profile, a Facebook post, a Twitter feed, a Pinterest pin, an Instagram photo, an RSS feed, a Podcast, and a web page.

16. The email message method of claim 13, wherein displaying the at least one information element comprises displaying a content of the linked information element associated with the selected email message.

17. The email message method of claim 13, further comprising displaying the at least one information element comprises displaying a link to the linked information element associated with the selected email message.

18. The email message method of claim 13, further comprising displaying the at least one information element comprises displaying an address to the linked information element associated with the selected email message.

19. The email message method of claim 13, further comprising associating with the selected email message at least one information element stored on a computer on which the email message system resides.

20. The email message method of claim 13, further comprising associating with the selected email message at least one information element stored in a computer wirelessly coupled to a computer running the email message system.

21. The email message method of claim 13, further comprising associating with the selected email message at least one information element stored in a computer that is part of the Internet.

22. The email message method of claim 13, further comprising:
displaying a list of link options in response to receiving the user selection of the particular email message; and
receiving user input of the information item.

23. The email message method of claim 22, wherein receiving user input of the information item comprises displaying a window adapted to receive user input.

24. The email message method of claim 22, wherein receiving user input of the information item comprises displaying a browse file dialog.

25. An email message method comprising:
displaying, in a first area on a screen, a collection of a plurality of email messages;
receiving a user selection of a particular email message from the collection;
receiving user input to associate at least one information element with the selected email message, the at least one information element selected from the group consisting of a note, a file, a task, a contact, an email message, a calendar item, a picture, and a web-based information element; and
displaying, in a second area on the screen separate from the first area, the at least one information element.
